(19) United States
(12) Patent Application Publication
(10) Pub. No.: US 2006/0245134 A1
(43) Pub. Date: Nov. 2, 2006

(54) Process for managing the current-surge that occurs when electric service is restored, following a power outage

(76) Inventor: Max Alexander Gratzl, Arlington, VA (US)

Correspondence Address: Max Alexander Gratzl, 4140 No 41 St, Arlington, VA, 22207, US

(21) Appl. No.: 11/271,761

(22) Filed: Nov. 10, 2005

Related U.S. Application Data
(60) Provisional application No. 60/675,657, filed on Apr. 29, 2005.

(51) Int. Cl. H02H 9/02

(52) U.S. Cl. 361/93.1

(57) ABSTRACT

A process for managing the current-surge that occurs when electric service is restored, following a power outage. In the initial embodiment, the device takes the form of a kit of, typically, six modules (Figure Two). The user inserts a module between the power plug of the appliance and the wall outlet. The modules insert a time-delay between the arrival of electric power at the wall, and delivery of that power to the affected appliance. The user selects from a choice of delays ranging from ten seconds to 100 seconds, in ten-second steps. Thus, the startups of affected appliances are sequenced such that the current-surges are distributed over ten-second intervals. No two or more delays should be the same, and simultaneous startups leading to combined current-surges are avoided, leading to aforementioned benefits.

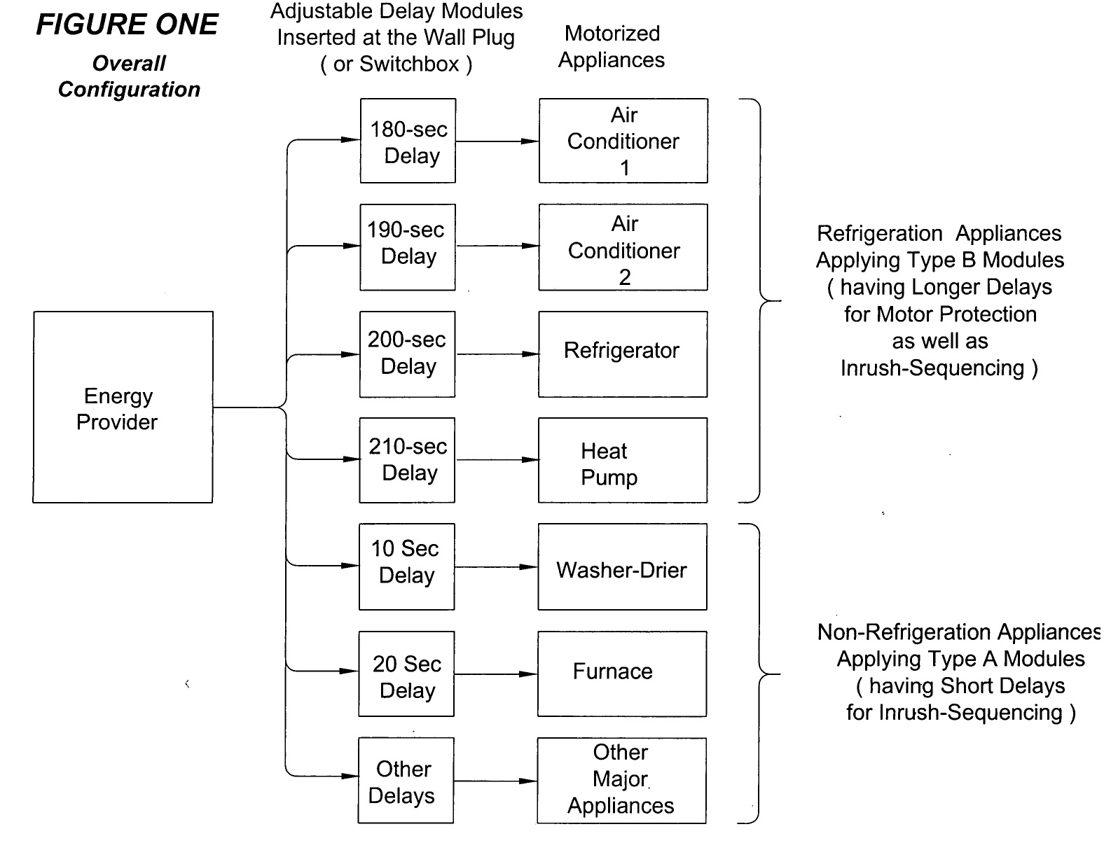

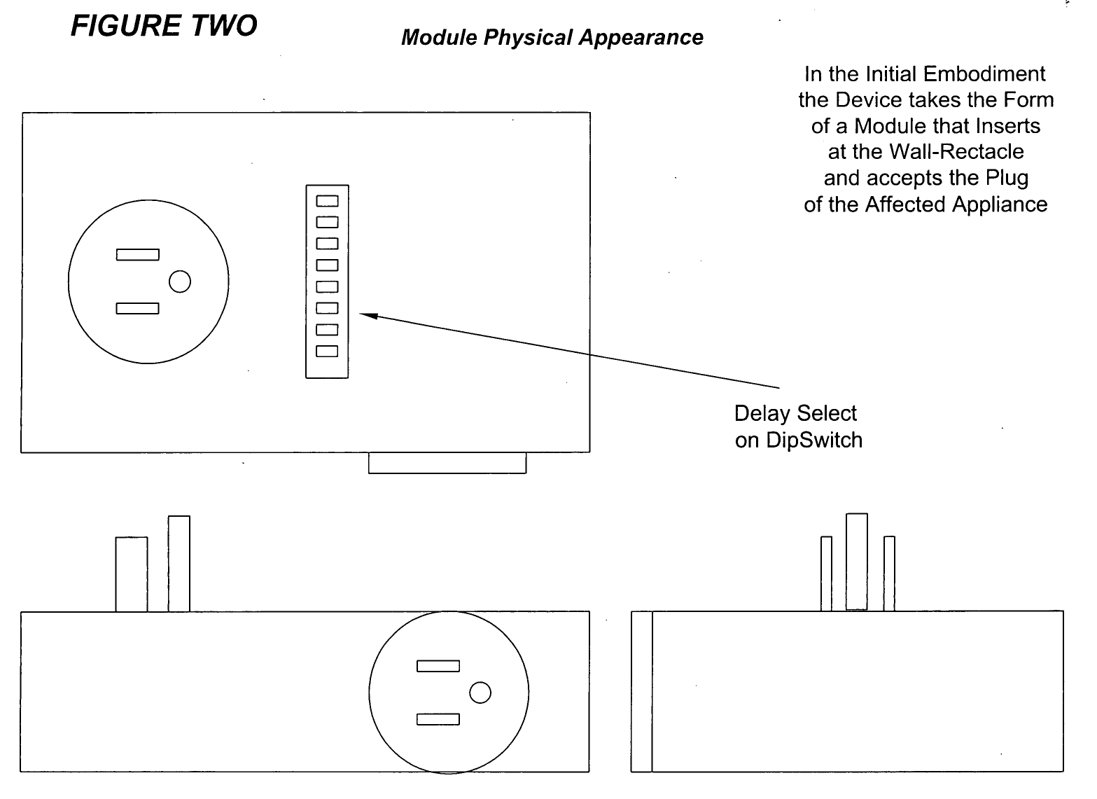

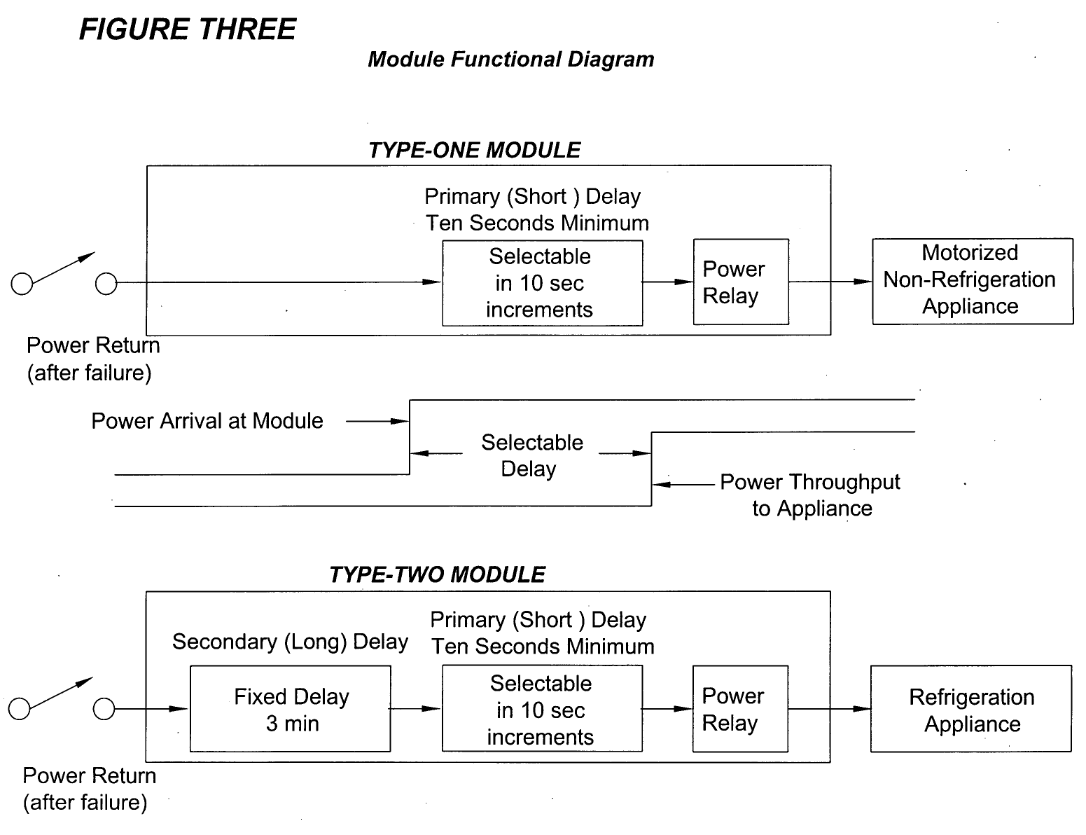

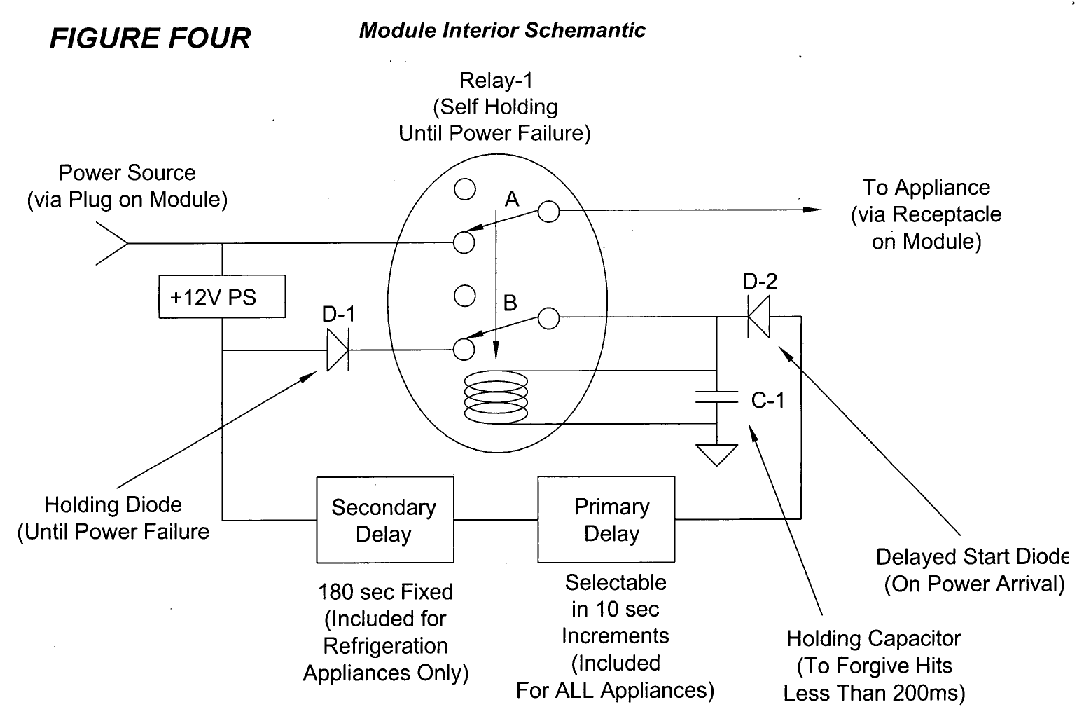

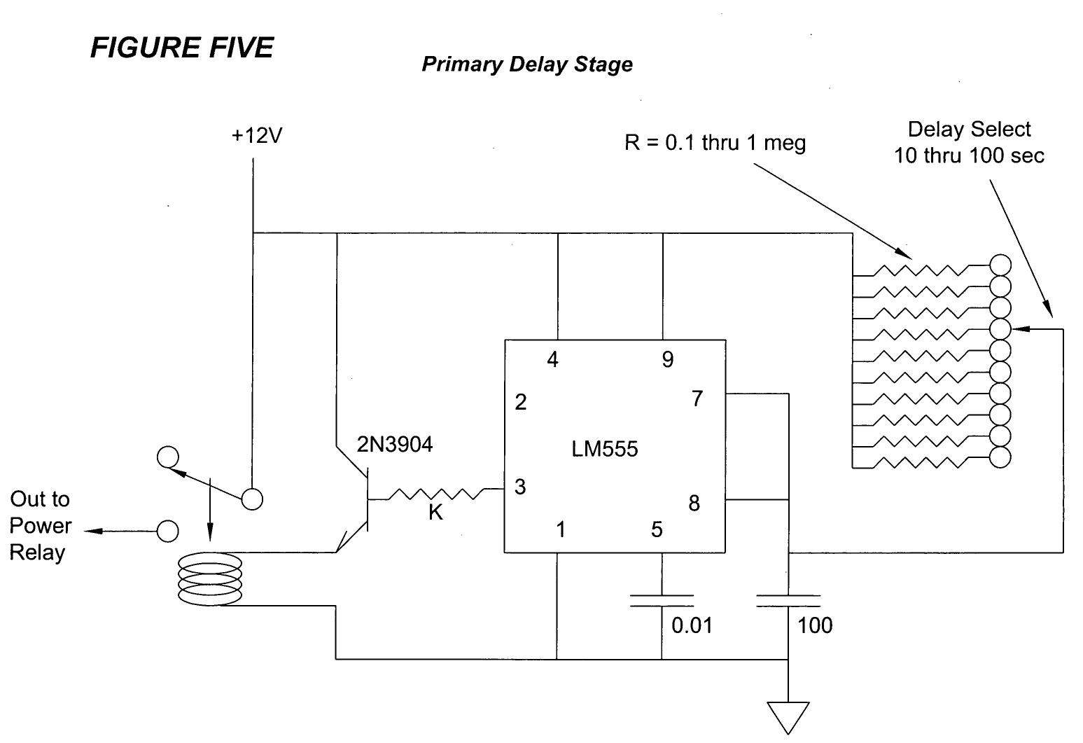

### CROSS REFERENCE TO RELATED APPLICATIONS

This application is based on provisional application Ser. No. 60/675,657, filed on Apr. 29, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Current-Surge Management, and more specifically to a process for managing the current-surge that occurs when electric service is restored, following a power outage.

Unlike the most closely-related technology (as seen from the Patent Search, following), which concerns itself with motor protection (consumption side), this method concerns itself with the power supply side, and the current-surge that it must support on power initiation (as in power restoration following a power outage).

The problem first came to the attention of the inventor when he tried to connect a back-up generator to his house. It stalled. It is necessary to turn off all major appliances before switching the load on to the generator. Then it is necessary to turn on the appliances one at a time. Why? Under normal conditions, an average household consumes power to drive a heat-pump (2 Kw), a refrigerator (1 Kw), a washing machine (1 Kw), computers and an assorment of smaller appliances (1 Kw). The total maximum is 5 Kw. But since these appliances are not on all the time, we might presume an average on-time of 50%. Thus the average power consumption is 5 Kw/2=2.5 Kw. When, however, power fails, all appliances stop. When power returns all appliances will re-start simultaneously. Now their run-times—as well as their respective start-up surges—will reinforce each other. Since this represents a current-surge of about ten-times normal, the restart demand is: 2.5×10=25 Kw.

While it is of short duration, it is far beyond the capability of a “reasonably” rated generator.

The problem also impacts the power utility because they also must absorb a current-surge (“inrush”) of 10× when they restore power to a territory, following a power outage. The power utility copes with the demand by:
1.) Over-designing the power distribution system to temporarily tolerate a 10× overload.
2.) Restoring power to small territories one at a time.

A Patent Search produced a wide variety of Motor Protection devices/methods. The most common were re-start delays intended for the protection of refrigeration appliances (heat pumps, refrigerators, air conditioners, de-humidifiers, etc). These require re-start-delays of about three minutes to allow the residual pressure in the condenser to subside before attempting to resume compression. A selection of relevant patents is: U.S. Pat. Nos. 5,455,469; 5, 627, 417; 6,647,316; 6,342, 840; 2,326,034 (UK); U.S. Pat. Nos. 2,385,525; 3,815,668; 4,045973; 4,307,775. Additional parents were scanned, under the classifications of (in order of relevance):

“Power Restoration AND Surge Reduction” (0),

“Electric Load Startup Sequencer” (0),

Refrigeration Compressor AND Delay-Relay” (10),

“Compressor and Restart-Delay” (26).

The Prior Technology, preceding, shows only tangential or spin-off solutions to the problem as described in the History of Technology. Accordingly, the USPTO granted to this inventor the existing Provisional Patent No. 60,675,657.

### BRIEF SUMMARY OF THE INVENTION

The primary object of Surge Management benefits the electric energy provider by reducing the capacity requirements of his distribution network.

Another object of Surge Management is benefits for the electric energy provider by expanding the size of territory that can be restored at any one time, following a power outage.

Another object of Surge Management benefits is for the user of a backup electric generator, by eliminating the need to turn off appliances before closing the generator connection; then turning them on again one at a time.

A further object of Surge Management is the reduction of the voltage-dip that accompanies power restoration, thus reducing current-surge duration.

Yet another object of the invention is reduced voltage-amplitude dip & dip-duration (above), which benefits appliances because starting intervals are shortened. The start-up is a very life-shortening function of the appliance.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for managing the current-surge that occurs when electric service is restored, following a power outage (Figure One).

In the initial embodiment, the device takes the form of a kit of, typically, six modules (Figure Two). The user inserts a module between the power plug of the appliance, and the wall outlet. The modules insert a time-delay between the arrival of electric power at the wall, and application of that power upon the affected appliance. The user selects from a choice of delays ranging from ten seconds to 100 seconds, in ten-second steps. Thus, the startups of affected appliances are sequenced such that the current-surges are distributed over ten-second intervals. No two or more delays should be the same, and simultaneous startups leading to combined current-surges are avoided, leading to aforementioned benefits.

Claim One:

In the initial and introductory embodiment, delay modules may be inserted between the wall receptacle, and the plug by which the affected appliance would normelly be connected.

Claim Two:

Delay modules may be inserted in the appliances by the manufacturer.

Claim Three:

Delay modules may be inserted in the breaker box, either by the breaker box manufacturer or by an aftermarket breaker manufacturer.

### BRIEF DESCRIPTION OF THE DRAWINGS

The drawings constitute a part of this specification and include exemplary embodiments to the invention, which may be embodied in various forms.

It is to be understood that in some instances various aspects of the invention may be shown exaggerated or enlarged to facilitate an understanding of the invention.

Figure One

is an Overall Configuration & Timing Diagram of the invention, as used in a typical household.

Figure Two

is an engineering drawing in real-size of a type-one or type-two module.

Figure Three

is a block diagram of the internal function of the modules.

Figure Four

is block diagram of the internal circuit.

Figure Five

is an electronic schematic of the timer block.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. Old technology concerned itself with motor protection. This is the area of power consumption. Our Patent Search showed almost no devices/methods that concerned themselves with the start-up stresses of power provision. Our new technology reduces the stresses imposed upon the power provider, while simultaneously offering an alternative technology for motor protection. Primarily intended for the reduction of burden at the supply-side, our method for sequencing start-up of household appliances is also a method for inserting a time-delay that some motors, particularly refrigeration compressor motors, require. Time delay alone does not describe our method. A sequence of different delays that avoids any and all possible simultaneous start-ups is the the more applicable description. Moreover, it is the same timing control that can be applied to the protection of motors. Thus our method benefits previous technology (motor protection), as well as future technology (energy delivery).

The Claims describe alternate embodiments of the method. Our initial embodiment is the one that is most compatible with the existing state of the energy industry. The other embodiments are desirable for future applications. They require adoption of the principle, and the cooperation of the manufacturers. The method and its alternate embodiments (Claims) will make a significant contribution to the continuing evolution of energy technology.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for managing the current-surge that occurs when electric service is restored, following a power outage comprising the steps of:
In the initial embodiment, the device takes the form of a kit of, typically, six modules (Figure Two);
The user inserts a module between the power plug of the appliance, and the wall outlet. The modules insert a time-delay between the arrival of electric power at the wall, and delivery of that power to the affected appliance. The user selects from a choice of delays ranging from ten seconds to 100 seconds, in ten-second steps. Thus, the startups of affected appliances are sequenced such that the current-surges are distributed over ten-second intervals. No two or more delays should be the same, and simultaneous startups leading to combined current-surges are avoided, leading to aforementioned benefits.
Delay modules may be inserted in the appliances by the manufacturer.
Delay modules may be inserted in the breaker box, either by the breaker box manufacturer or by an aftermarket breaker manufacturer.
